(19) United States
(12) Patent Application Publication
(10) Pub. No.: US 2017/0084234 A1
(43) Pub. Date: Mar. 23, 2017

(54) DRIVER CIRCUITS WITH SHARED NODE

(71) Applicant: QUALCOMM MEMS Technologies, Inc., San Diego, CA (US)

(72) Inventors: Heesun Shin, Seoul (KR); Cheonhong Kim, San Diego, CA (US); Bing Wen, Poway, CA (US); Jae Hyeong Seo, Pleasanton, CA (US)

(21) Appl. No.: 14/863,012

(22) Filed: Sep. 23, 2015

(51) Int. Cl. G09G 3/34

(52) U.S. Cl. CPC G09G 3/3466; G09G 2310/0251; G09G 2310/0291; G09G 2310/08; G09G 2330/021

(57) ABSTRACT

This disclosure provides systems, methods and apparatus for driver circuits with shared nodes. In one aspect, a circuit can drive and then float a charge node that is shared among multiple output buffers. The output buffers can include buffer charge nodes that are driven when the charge node is driven. When the charge node is floating, the output buffers can sequentially use the charge node to assert output signals.

### TECHNICAL FIELD

This disclosure relates to display driver circuits with shared nodes.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

In some implementations, each IMOD may include a movable element (e.g., a mirror) that can be moved to positions to reflect light at particular wavelengths. Row driver and column driver circuits can provide voltages to terminals of transistors and/or electrodes of the IMOD and in a particular sequence such that the movable element is properly positioned.

Row driver circuits can be implemented with thin film transistors (TFTs) on the glass of a display device rather than with traditional CMOS in silicon. Implementing the row driver circuits with TFTs is advantageous because it can make it possible to have a narrower bezel thanks to reduced number of routing lines than using an off-glass CMOS chip. However, TFT implementations can have higher power dissipation, and it is required to minimize the bezel width to get a compact form factor.

### SUMMARY

The systems, methods and devices of this disclosure each have several innovative aspects, no single one of which is solely responsible for the desirable attributes disclosed herein.

One innovative aspect of the subject matter described in this disclosure can be implemented in a circuit capable of biasing a first charge node and electrically coupling the biased charge node with buffer charge nodes of a set of output buffers in a first phase, and capable of sequentially electrically coupling the buffer charge nodes of the output buffers of the set of output buffers in a second phase occurring after the first phase, the first charge node floating during the second phase, and corresponding outputs of the output buffers being sequentially asserted during the second phase.

In some implementations, the set of output buffers can include a first buffer comprising a first switch having a first terminal and a second terminal, the first terminal coupled with the first charge node; a second switch having a first terminal and a second terminal, the first terminal coupled with the first charge node, and the second terminal coupled with the second terminal of the first switch to define a first buffer charge node of the buffer charge nodes.

In some implementations, the first switch can have a control terminal coupled with a first clock, and the second switch can have a control terminal coupled with a second clock, the second switch turned on by the second clock during the first phase, the first switch turned on by the first clock during the second phase.

In some implementations, the circuit can have a third switch having a first terminal, a second terminal, and a control terminal, the control terminal coupled with the first buffer charge node, the first terminal coupled with the first clock, the second terminal to provide a first output of the corresponding outputs of the output buffers.

In some implementations, the circuit can have a fourth switch having a first terminal and a control terminal, the first terminal coupled with the second terminal of the third switch, the control terminal coupled with a second charge node.

In some implementations, the circuit can have a capacitor having a first terminal and a second terminal, the first terminal coupled with the first buffer charge node, and the second terminal coupled with the second terminal of the third switch.

In some implementations, the set of output buffers can include a first output buffer and a second output buffer, the second phase includes a first period and a second period, an output of the first output buffer asserted and an output of the second output de-asserted during the first period, the output of the first output buffer de-asserted and the output of the second output asserted during the second period.

In some implementations, the first output buffer can include a first buffer charge node and the second output buffer includes a second buffer charge node, the first buffer charge node electrically coupled with the charge node in the first period, the second buffer charge node electrically coupled with the charge node in the second period.

In some implementations, the circuit can have a display including a plurality of display elements; a processor that is configured to communicate with the display, the processor being configured to process image data; and a memory device that is configured to communicate with the processor.

In some implementations, the circuit can have a driver circuit including the circuit and configured to send at least one signal to the display; and a controller configured to send at least a portion of the image data to the driver circuit.

In some implementations, the circuit can have an image source module configured to send the image data to the processor, wherein the image source module includes a component selected from the group consisting of at least one of a receiver, a transceiver, and a transmitter.

In some implementations, the corresponding outputs of the output buffers being sequentially asserted during the second phase can include assertions of a first row signal, a carry signal, and a second row signal, the carry signal asserted after the first row signal and before the second row signal.

Another innovative aspect of the subject matter described in this disclosure can be implemented in a circuit having a latch circuit capable of driving a charge node in a first operation and floating the charge node in a second operation; a first output buffer coupled with the charge node, the first output buffer having a first output buffer charge node; and a second output buffer coupled with the charge node, the first output buffer having a second output buffer charge node, wherein both the first output buffer charge node and the second output buffer charge node are driven using the charge node during the first operation, and one of the first output buffer charge node and the second output buffer charge node is driven using the charge node during the second operation to assert an output signal corresponding to an output of the one of the first output buffer charge node and the second output buffer charge node.

In some implementations, the first output buffer can have a first switch having a first terminal and a second terminal, the first terminal coupled with the charge node; a second switch having a first terminal and a second terminal, the first terminal coupled with the charge node, and the second terminal coupled with the second terminal of the first switch to define the first output buffer charge node.

In some implementations, the first switch can have a control terminal coupled with a first clock, and the second switch has a control terminal coupled with a second clock, the second switch turned on by the second clock during the first phase, the first switch turned on by the first clock during the second phase.

In some implementations, the second output buffer can have a third switch having a first terminal and a second terminal, the first terminal coupled with the charge node; a fourth switch having a first terminal and a second terminal, the first terminal coupled with the charge node, and the second terminal coupled with the second terminal of the third switch to define the second buffer charge node.

In some implementations, the third switch can have a control terminal coupled with a third clock, and the fourth switch has a control terminal coupled with the second clock, the fourth switch turned on by the second clock during the first phase, the third switch turned on by the third clock during the second phase after the first switch is turned on.

In some implementations, the circuit can have a third output buffer coupled with the charge node.

Another innovative aspect of the subject matter described in this disclosure can be implemented in method comprising driving a charge node of a circuit; turning on a first switch of a first output buffer and a second switch of a second output buffer to drive a first output buffer charge node of the first output buffer and a second output buffer charge node of the second output buffer; floating the charge node; turning off the first switch and the second switch; and turning on a third switch of the first output buffer to drive the first output buffer charge node based on the floating charge node, wherein the second output buffer charge node is floating.

In some implementations, the method can comprise asserting an output of the first output buffer responsive to the third switch turning on.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5A is an illustration of a frame of display data in a three element by three element array of IMOD display elements displaying an image.

FIG. 5B is a timing diagram for common and segment signals that may be used to write data to the display elements illustrated in FIG. 5A.

FIGS. 6A and 6B are schematic exploded partial perspective views of a portion of an electromechanical systems (EMS) package including an array of EMS elements and a backplate.

FIG. 7 is an example of a system block diagram illustrating an electronic device incorporating an IMOD-based display.

FIG. 8 is a circuit schematic of an example of a three-terminal IMOD.

FIG. 9A is an example of a system block diagram illustrating integrated bias driver circuits providing signals to single rows of IMODs.

FIG. 9B is an example of a system block diagram illustrating an integrated bias driver circuit providing signals to multiple rows of IMODs.

FIG. 10 is a circuit schematic of an example of an integrated bias driver circuit.

FIG. 11 is an example of a timing diagram for the integrated bias driver circuit of FIG. 10.

FIG. 12 is a flow diagram illustrating a method for operation of an integrated bias driver circuit.

FIG. 13 is an example of a system block diagram illustrating an integrated gate driver circuit providing signals to IMODs.

FIG. 14 is a circuit schematic of an example of an integrated gate driver circuit.

FIGS. 15A-15C are circuit schematics of examples of output buffers of an integrated gate driver circuit.

FIG. 16 is an example of a timing diagram for operation of an integrated gate driver circuit.

FIG. 17 is a flow diagram illustrating a method for operation of an integrated gate driver circuit.

FIGS. 18A and 18B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Active matrix flat panel displays such as active matrix liquid crystal displays, organic light emission displays, and interferometric modulator (IMOD) displays can use thin film transistors (TFTs) on glass substrates to implement driver circuits providing a sequence of voltages to terminals of transistors and/or electrodes of display elements, such as IMODs. Implementing the row driver circuits with TFTs is advantageous because it can make it possible to have a narrower bezel thanks to reduced number of routing lines than using an off-glass CMOS chip. However, TFT implementations can have higher power dissipation, and it is required to reduce the bezel width to get a compact form factor for the display.

Some implementations of the subject matter described in this disclosure reduce the area used to implement driver circuits, which results in a narrow border width of the bezel of the display. An integrated bias driver circuit can be used to provide a voltage to bias terminals of multiple rows of IMODs in the display. Additionally, an integrated row driver circuit and integrated gate driver circuit can include a latch stage providing a shared node to multiple output buffers that can sequentially use the shared node to drive their respective outputs.

Particular implementations of the subject matter described in this disclosure can be implemented to realize one or more of the following potential advantages. Reducing the number of TFTs used to implement driver circuits may result in reduced costs, decreased power requirements, and narrower bezel around the display, resulting in a sleeker device.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

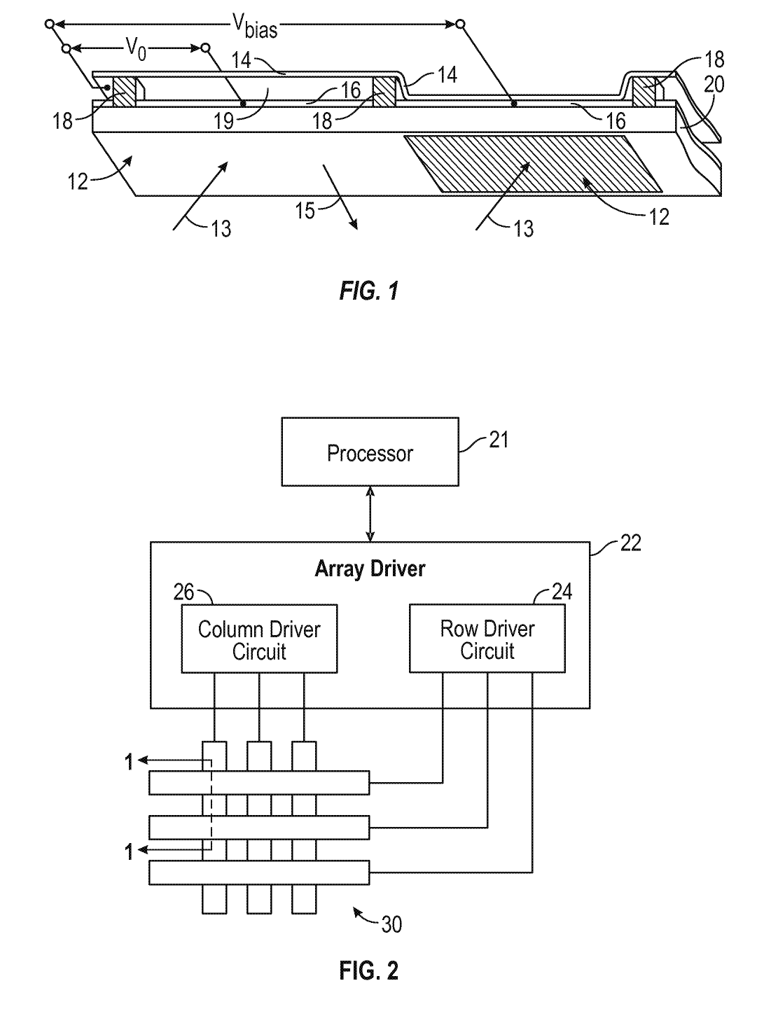

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

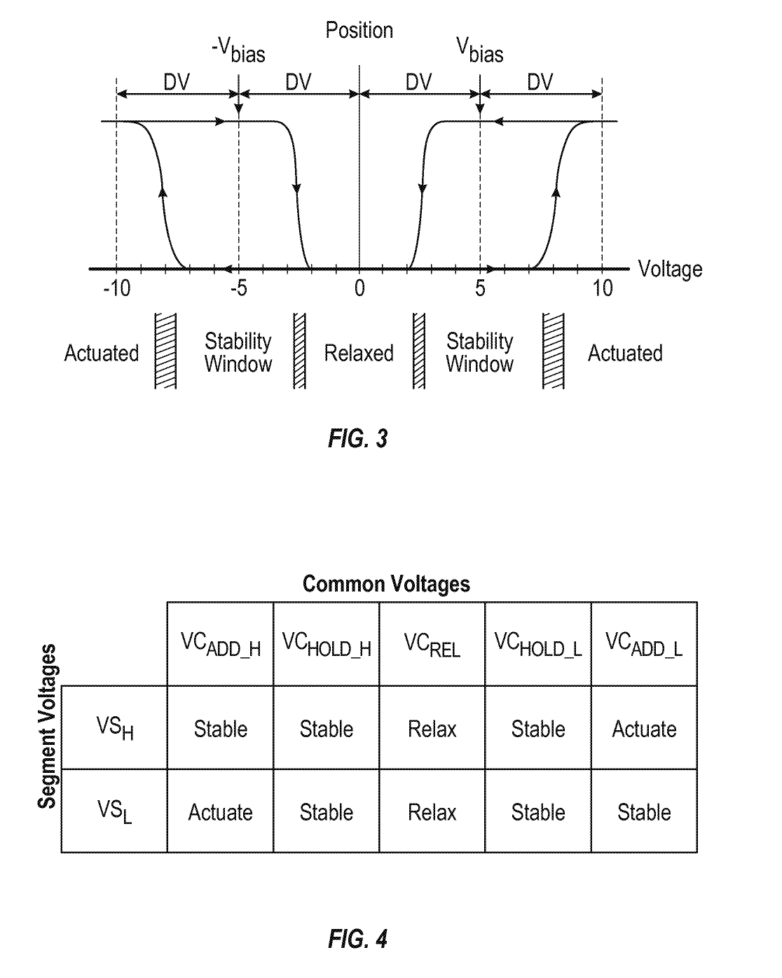

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_}_{H} or a low hold voltage VC_{HOLD}_{_}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_}_{H} or a low addressing voltage VC_{ADD}_{_}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

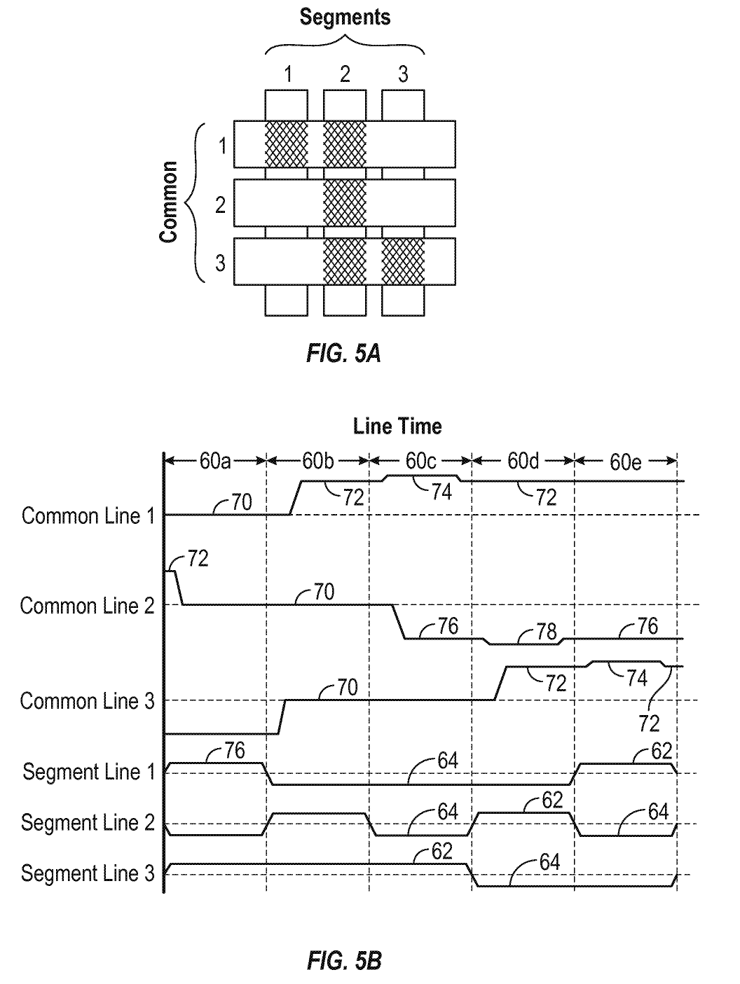

FIG. 5A is an illustration of a frame of display data in a three element by three element array of IMOD display elements displaying an image. FIG. 5B is a timing diagram for common and segment signals that may be used to write data to the display elements illustrated in FIG. 5A. The actuated IMOD display elements in FIG. 5A, shown by darkened checkered patterns, are in a dark-state, i.e., where a substantial portion of the reflected light is outside of the visible spectrum so as to result in a dark appearance to, for example, a viewer. Each of the unactuated IMOD display elements reflect a color corresponding to their interferometric cavity gap heights. Prior to writing the frame illustrated in FIG. 5A, the display elements can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. In some implementations, the segment voltages applied along segment lines 1, 2 and 3 will have no effect on the state of the IMOD display elements, as none of common lines 1, 2 or 3 are being exposed to voltage levels causing actuation during line time 60a (i.e., VC_{REL}−relax and VC_{HOLD}_{_}_{L}−stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the display element voltage across modulators (1,1) and (1,2) is greater than the high end of the positive stability window (i.e., the voltage differential exceeded a characteristic threshold) of the modulators, and the modulators (1,1) and (1,2) are actuated. Conversely, because a high segment voltage 62 is applied along segment line 3, the display element voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the display element voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state. Then, the voltage on common line 2 transitions back to the low hold voltage 76.

Finally, during the fifth line time 60e, the voltage on common line 1 remains at high hold voltage 72, and the voltage on common line 2 remains at the low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 display element array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the display element voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5A. In some other implementations, voltages applied along common lines or segment lines may vary to account for variations in the actuation and release voltages of different modulators, such as modulators of different colors.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

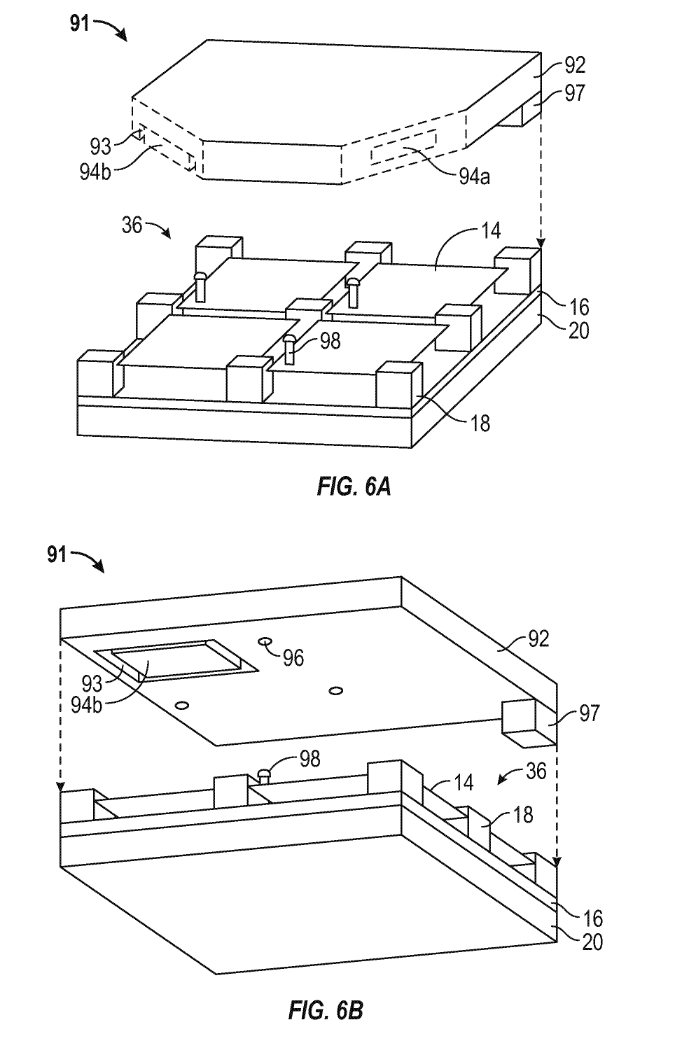

FIGS. 6A and 6B are schematic exploded partial perspective views of a portion of an EMS package 91 including an array 36 of EMS elements and a backplate 92. FIG. 6A is shown with two corners of the backplate 92 cut away to better illustrate certain portions of the backplate 92, while FIG. 6B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 6A and 6B, the backplate 92 can include one or more backplate components 94a and 94b, which can be partially or wholly embedded in the backplate 92. As can be seen in FIG. 6A, backplate component 94a is embedded in the backplate 92. As can be seen in FIGS. 6A and 6B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 6B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 6A and 6B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 6A and 6B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

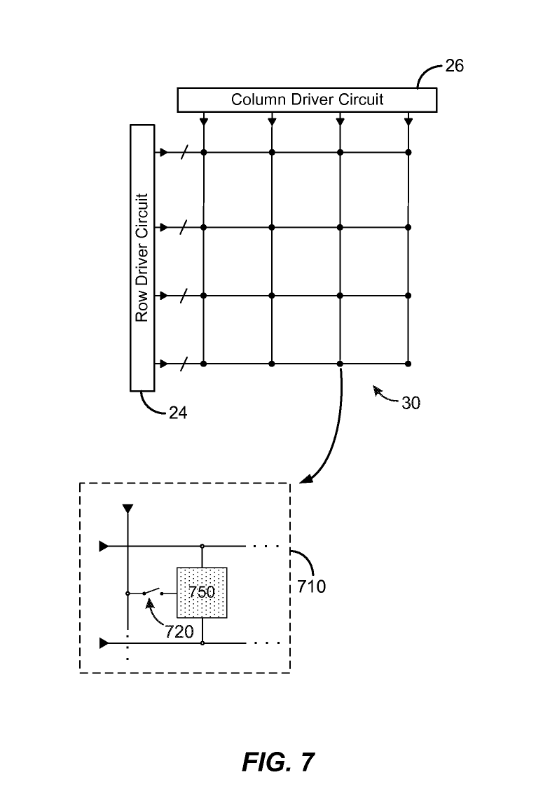

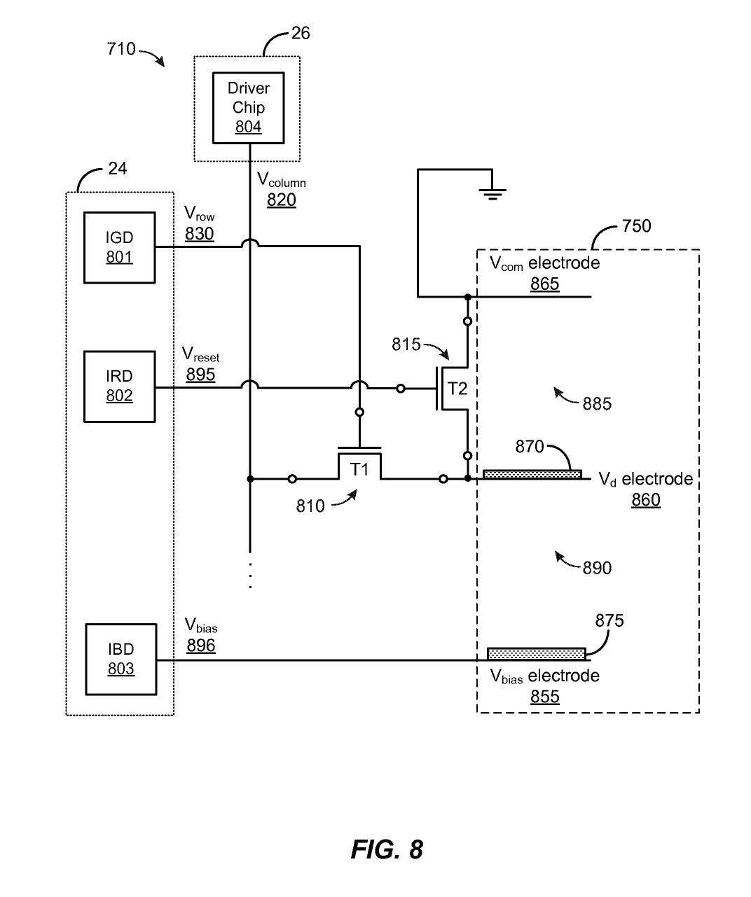

FIG. 7 is an example of a system block diagram illustrating an electronic device incorporating an IMOD-based display. FIG. 7 depicts an implementation of row driver circuit 24 and column driver circuit 26 of array driver 22 of FIG. 2 that provide signals to display array or panel 30, as previously discussed.

The implementation of display module 710 in display array 30 may include a variety of different designs. As an example, display module 710 in the fourth row includes switch 720 and display unit 750. Display module 710 may be provided a row signal, reset signal, and a bias signal from row driver circuit 24. Display module 710 may also be provided a column (or data) signal and a common signal from column driver circuit 26. Display unit 750 may be coupled with switch 720, such as a transistor with its gate coupled to the row signal and its drain coupled with the column signal. Each display unit 750 may include an IMOD display element as a pixel.

Some IMODs are three-terminal devices that use a variety of signals. FIG. 8 is a circuit schematic of an example of a three-terminal IMOD. In the example of FIG. 8, display module 710 includes display unit 750 (e.g., an IMOD). The circuit of FIG. 8 also includes switch 720 of FIG. 7 implemented as an n-type metal-oxide-semiconductor (NMOS) transistor T1 810. The gate of transistor T1 810 is coupled to receive voltage V_{row} 830 (i.e., a control terminal of transistor T1 810 is coupled to receive V_{row} 830 providing a row select signal) from row driver circuit 24 of FIG. 7 as a row signal. Transistor T1 810 is also coupled to receive V_{column} 820, which may be a voltage provided by column driver circuit 26 of FIG. 7 as a data signal. If V_{row} 830 is at a voltage to turn transistor T1 810 on, the voltage on V_{column} 820 may be applied to V_{d} electrode 860 of display unit 750. The circuit of FIG. 8 also includes another switch implemented as an NMOS transistor T2 815. The gate (or control) of transistor T2 815 is coupled with to receive Vᵣₑₛₑₜ 895 as a reset signal. The other two terminals of transistor T2 815 are coupled with V_{com} electrode 865 and V_{d} electrode 860. When transistor T2 815 is turned on (e.g., by a voltage of a reset signal on Vᵣₑₛₑₜ 895 applied to the gate of transistor T2 815), V_{com} electrode 865 and V_{d} electrode 860 may be shorted together.

In FIG. 8, display unit 750 is a three-terminal IMOD including three terminals or electrodes: V_{bias} electrode 855, V_{d} electrode 860, and V_{com} electrode 865. Display unit 750 may also include movable element 870 and dielectric 875. Movable element 870 may include a mirror. Movable element 870 may be coupled with V_{d} electrode 860. Additionally, air gap 890 may be between V_{bias} electrode 855 and V_{d} electrode 860. Air gap 885 may be between V_{d} electrode 860 and V_{com} electrode 865. As movable element 870 is positioned, the sizes of air gaps 885 and 890 may change. In some implementations, display unit 750 may also include one or more capacitors. For example, one or more capacitors can be coupled between V_{d} electrode 860 and V_{com} electrode 865 and/or between V_{bias} electrode 855 and V_{d} electrode 860.

Movable element 870 can be positioned at points, or locations, between V_{bias} electrode 855 and V_{com} electrode 865 to provide light at a specific wavelength at each specific point. In particular, voltages applied to V_{bias} electrode 855, V_{d} electrode 860, and V_{com} electrode 865 may determine the position of movable element 870. Voltages for Vᵣₑₛₑₜ 895, V_{column} 820 (which is applied to V_{d} electrode 860 if transistor T1 810 is turned on), V_{row} 830, V_{com} electrode 865, and V_{bias} 896 (to be applied to V_{bias} electrode 855) may be provided by driver circuits such as row driver circuit 24 and column driver circuit 26. In some implementations, V_{com} electrode 865 may be coupled to ground rather than driven by row driver circuit 24 or column driver circuit 26, as depicted in FIG. 8.

In FIG. 8, row driver circuit 24 includes several circuits providing voltages to display module 710 to position movable element 870: integrated gate driver (IGD) 801 providing V_{row} 830, integrated row driver (IRD) 802 providing Vᵣₑₛₑₜ 805, and integrated bias driver (IBD) 803 providing V_{bias} 896. Additionally, column driver circuit 26 includes driver chip 804 providing V_{column} 820.

Generally, Vᵣₑₛₑₜ 895 is asserted (or applied by providing a voltage pulse from low to high voltage) by row driver circuit 24 (e.g., initiated by driver controller 29, or another controller, providing signals to row driver circuit 24 to begin) to turn on transistor T1 810 to short V_{com} electrode 865 and V_{d} electrode 870 to position movable element 870 to a reset position. Vᵣₑₛₑₜ 895 can then be de-asserted (e.g., switched from a high voltage to a low voltage to turn off transistor T1 810) and column driver circuit 26 can provide V_{column} 820 (at a voltage based on the intended position to move movable element 870 towards) and row driver circuit 24 can assert V_{row} 830 such that transistor T1 810 is turned on and the voltage on V_{column} 820 is applied to V_{d} electrode 860 of display unit 750. The voltage of V_{bias} 896 can also be changed to provide different voltages on V_{bias} electrode 855. For example, before Vᵣₑₛₑₜ 895 is asserted, row driver circuit 24 can apply a 0 V V_{bias} 896 to have V_{bias} electrode 855 also be 0 V, but change V_{bias} 896 to a higher or lower voltage following the application of V_{column} 820 and V_{row} 830 based on a polarity of display unit 750 (e.g., the directions of the electric fields between the electrodes of display unit 750). This process may occur row-by-row until each movable element 870 in each row of display modules 710 is positioned. For example, Vᵣₑₛₑₜ 895 for a first row of display modules 710 may be asserted, followed by a second row, followed by a third row, and so on until each row of display modules 710 have had their corresponding Vᵣₑₛₑₜ 895 asserted. Likewise, V_{row} 830 for rows of display modules 710 can also be asserted row-by-row. V_{row} 830 for one row may be asserted while Vᵣₑₛₑₜ 895 for another row is also asserted at the same or similar times. V_{bias} 896 may also be asserted row-by-row.

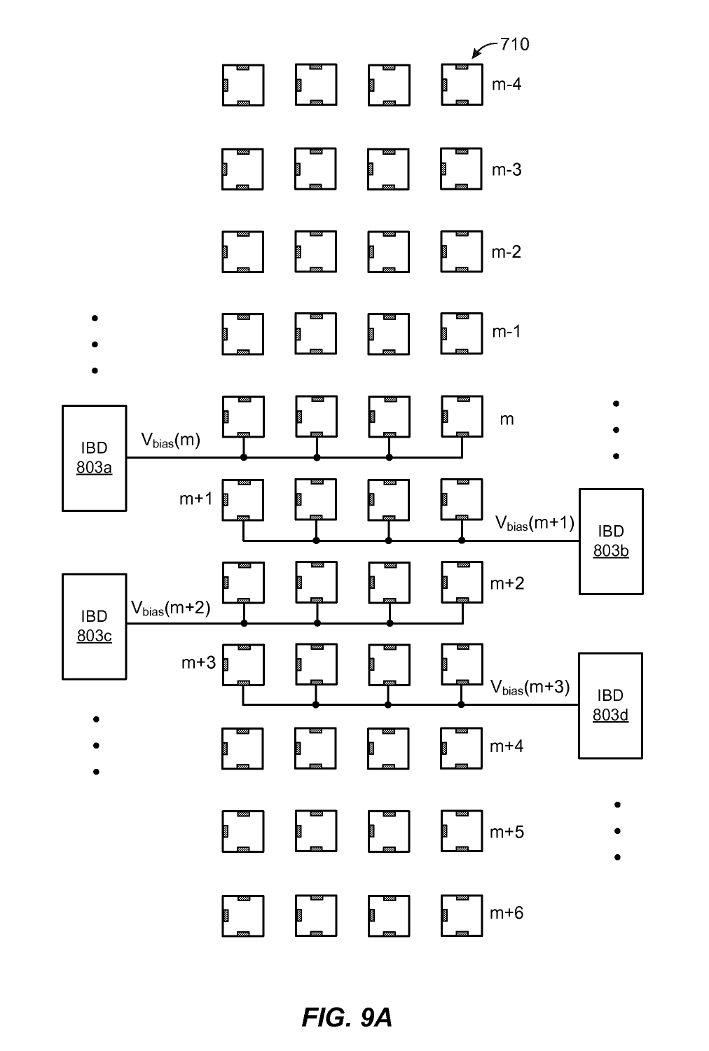

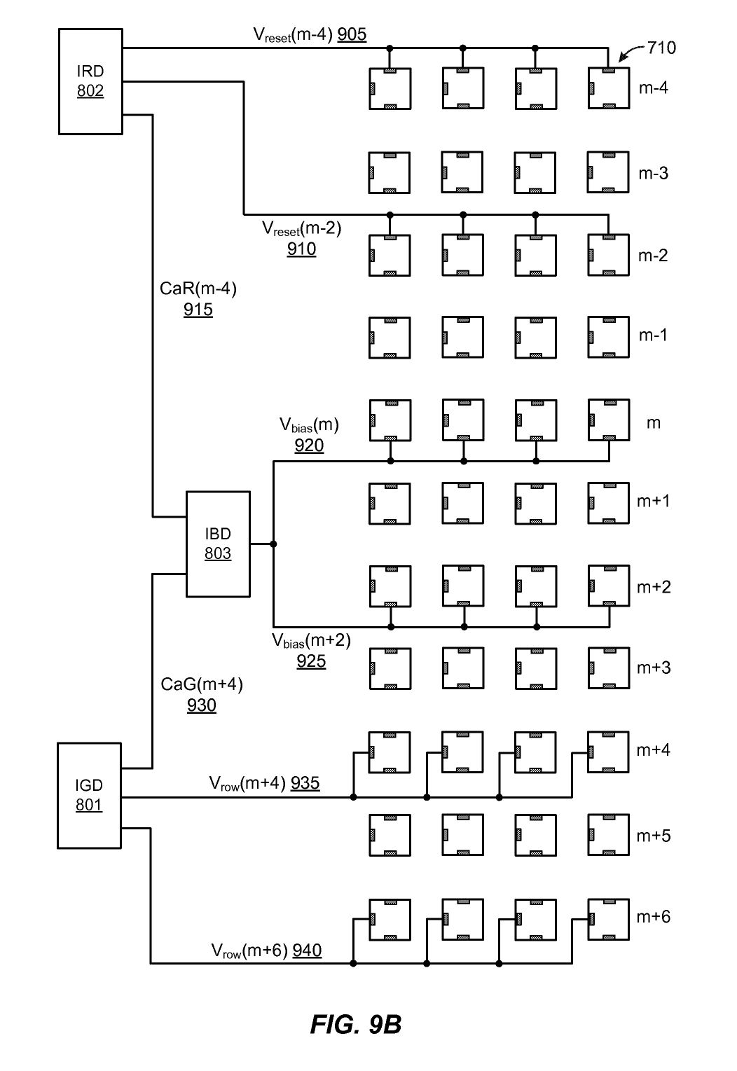

In some applications, each row of display modules 710 is provided V_{row} 830, Vᵣₑₛₑₜ 895, and V_{bias} 896 from separate IGD 801, IRD 802, and IBD 803 circuits, respectively. FIG. 9A is an example of a system block diagram illustrating integrated bias driver circuits providing signals to single rows of IMODs. In FIG. 9A, IBDs 803a-803d provide V_{bias} 896 for individual rows of display units 750 of display modules 710. For example, IBD 803a provides V_{bias}(m) for row m of display modules 710. IBD 803b V_{bias}(m+1) for row m+1 of display modules 710

Driver chip 804 in FIG. 8 may be implemented in CMOS in silicon as a chip-on-glass (COG) implementation. The circuits of row driver circuit 24 (i.e., IBDs, IRDs, and IGDs) may be implemented with TFTs on the glass (i.e., implemented upon a glass substrate) of display array 30 of a display device. However, implementing the row driver circuits with TFTs on the glass can be more expensive than a CMOS implementation. TFT implementations can also use more power and have lower reliability than CMOS implementations. Additionally, implementing TFTs on the glass of the display device can result in a wider bezel around the display device, and therefore, a bulkier display device. Accordingly, reducing the number of TFTs to implement IGD 801, IRD 802, and IBD 803 may allow reduced costs, lower power requirements, increased reliability, and a narrower bezel.

FIG. 9B is an example of a system block diagram illustrating an integrated bias driver circuit providing signals to multiple rows of IMODs. The circuit of FIG. 9B can also be used to implement an integrated row driver circuit. By contrast to FIG. 9A, in FIG. 9B, IBD 803 provides V_{bias} 896 to be applied to V_{bias} electrodes 855 of multiple rows of display units 750 of display modules 710 rather than a single row, resulting in a reduced number of TFTs used to implement row driver circuit 24 and IBD 803.

In FIG. 9B, IBD 803 provides both V_{bias}(m) 920 (i.e., V_{bias} 896 in FIG. 8 to be provided to V_{bias} electrodes 855 for each of the display units 750 of display modules 710 in row m) and V_{bias}(m+2) 925 (i.e., V_{bias} 896 to be provided to V_{bias} electrodes 855 for each of the display units 750 of display modules 710 in row m+2). Moreover, IRD 802 provides both Vᵣₑₛₑₜ(m−4) 905 (i.e., V_{row} 830 for each of the display modules 710 in row m−4) and Vᵣₑₛₑₜ(m−2) 910 (i.e., V_{row} 830 for each of the display modules 710 in row m−2). IGD 801 provides both V_{row}(m+4) 935 (i.e., V_{row} 830 for each of the display modules 710 in row m+4) and V_{row}(m+6) 940 (i.e., V_{row} 830 for each of the display modules 710 in row m+6). IRD 802 and IGD 801 also provide CaR(m−4) 915 and CaG(m+4) 930, respectively, to IBD 803. CaR(m−4) 915 and CaG(m+4) 930 may be “carry” signals asserted by IRD 802 and IGD 801, respectively, when other signals are asserted. For example, IRD 802 may assert CaR(m−4) 915 when (or after) Vᵣₑₛₑₜ(m−4) 905 is asserted. Likewise, IGD 801 may assert CaG(m+4) 930 when (or after) V_{row}(m+4) 935 is asserted.

Though not shown, other pairs of rows (e.g., rows m+1 and m+3) may be provided corresponding voltages for V_{bias} electrodes 855 of the display units 750 of display modules 710 of the rows from other IBDs 803 similar to the implementation shown in FIG. 9. Likewise, other pairs of rows may be provided corresponding reset and row signals by IRDs and IGDs.

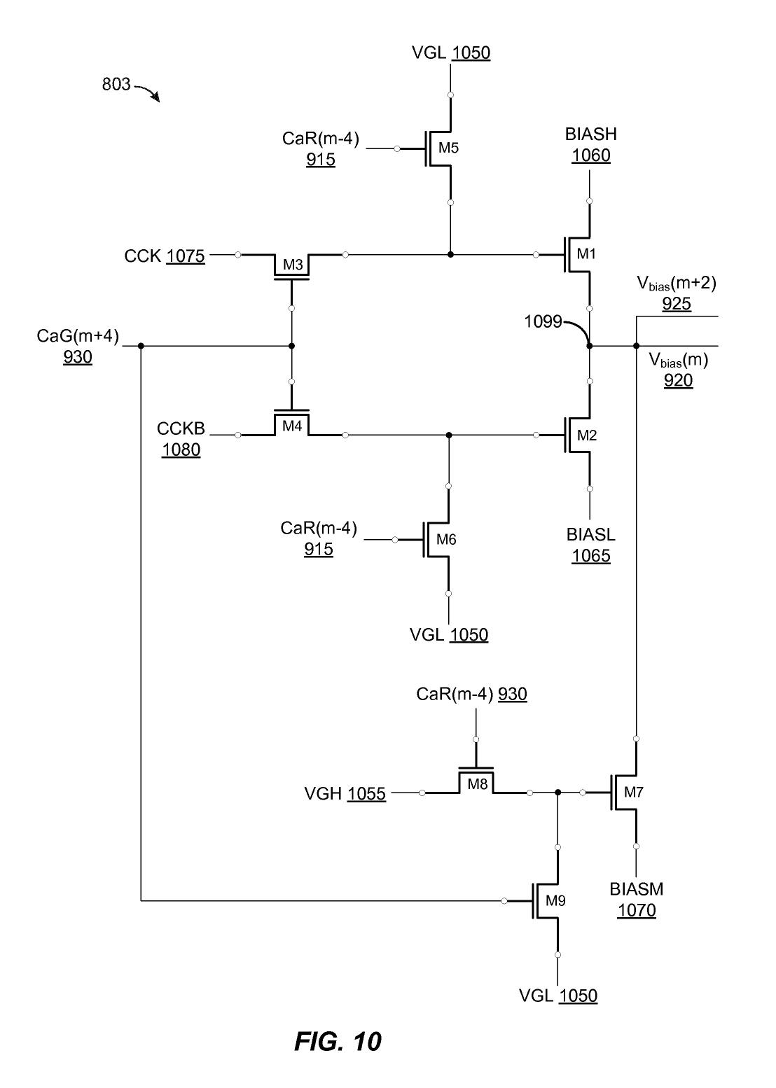

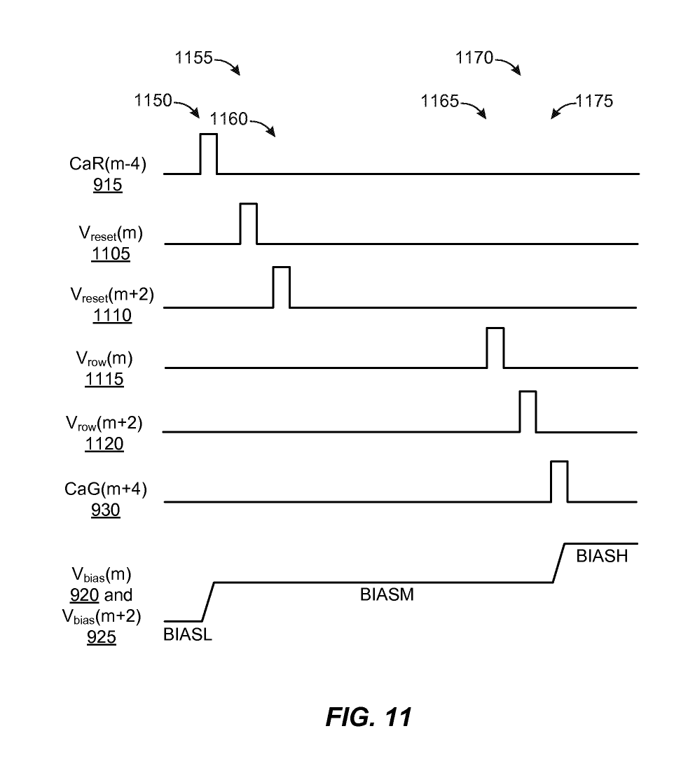

FIG. 10 is a circuit schematic of an example of an integrated bias driver circuit. FIG. 11 is an example of a timing diagram for the integrated bias driver circuit of FIG. 10. In FIG. 10, IBD 803 includes V_{bias}(m+2) 925 and V_{bias}(m) 920 provided by the same output node 1099 provided by an output buffer including transistors M1, M2, and M7. As a result, IBD 803 in FIG. 10 provides both V_{bias}(m+2) 925 and V_{bias}(m) 920 rather than having one IBD to provide V_{bias}(m) 920 and another IBD to provide V_{bias}(m+2) 925. That is, rather than providing voltages for V_{bias} electrodes 855 sequentially row-by-row, multiple rows (e.g., two in the example of FIG. 10) can be provided at the same or similar times with the IBD 803 in FIG. 10, resulting in a lower number of TFTs used to provide V_{bias}(m+2) 925 and V_{bias}(m) 920.

Some of the functionality of the integrated bias driver circuit in FIG. 10 can be similar to circuitry described in U.S. patent application Publication Ser. No. 14/476,380, titled ROBUST DRIVER WITH MULTI-LEVEL OUTPUT, by Kim et al., filed on Sep. 3, 2014, which is hereby incorporated by reference in its entirety and for all purposes.

In FIG. 10, V_{bias}(m) 920 and V_{bias}(m+2) 925 can both be driven by one of transistors M1, M2, and M7 to provide a voltage of BIASH, BIASL, or BIASM, respectively, at the output node. In some implementations, the voltage of BIASH may be higher than BIASM, and the voltage of BIASL may be lower than the voltage of BIASM. For example, BIASH may be 8 V, BIASM may be 0 V, and BIASL may be −8 V.

V_{bias}(m) 920 and V_{bias}(m+2) 925 can be asserted based on a timing relationship with the assertion of V_{row} 830 and Vᵣₑₛₑₜ 895 for rows m and m+2, as well as other signals from prior and subsequent rows.

For example, In FIG. 11, at time 1150, CaR(m−4) 915 may be asserted by IRD 802 in FIG. 9B it asserts Vᵣₑₛₑₜ(m−4) 905. CaR(m−4) 915 is provided as an input to IBD 803 which triggers V_{bias}(m) 920 and V_{bias}(m+2) 925 to a voltage of BIASM (e.g., 0 V). At times 1155 and 1160, Vᵣₑₛₑₜ (m) 1105 and Vᵣₑₛₑₜ(m+2) 1110 are asserted (by an IRD which asserts the signals after IRD 802 in FIG. 9B), respectively. As previously discussed, this may short V_{d} electrode 870 and V_{com} electrode 865 of display units 750 of each of the display modules 710 in rows m and m+2. If V_{com} electrode 865 is grounded at 0 V, then each of V_{bias} electrode 855, V_{d} electrode 860, and V_{com} electrode 865 would be at 0 V_{com} Accordingly, since CaR(m−4) 915 is provided by IRD 802 in FIG. 9B when it asserts Vᵣₑₛₑₜ(m−4) and Vᵣₑₛₑₜ(m−2) for prior rows (i.e., rows that are reset prior to rows m and m+2), CaR(m−4) 915 can also be used as a trigger for IBD 803 to set the output node to BIASM before the assertion of Vᵣₑₛₑₜ(m) 1105 and Vᵣₑₛₑₜ(m+2) 1110 by another IRD.

Next, at times 1165 and 1170, V_{row}(m) 1115 and V_{row}(m+2) 1120 can be asserted, respectively, by an IGD to provide a voltage to V_{d} electrode 860 of display units 750 of display modules 710 in rows m and m+2. The IGD providing V_{row} 830 voltages for row m+4 of display units 750 can also assert CaG(m+4) when V_{row} 830 is asserted for row m+4. CaG(m+4) is also provided as an input to IBD 803 as a trigger to transition V_{bias}(m) 920 and V_{bias}(m+2) 925 from BIASM to either BIASH or BIASL. For example, at time 1175 in FIG. 11, CaG(m+4) 930 is asserted, triggering V_{bias}(m) 920 and V_{bias}(m+2) 925 to switch from BIASM to BIASH after the assertion of V_{row}(m+2) 1120. In some implementations, V_{bias}(m) 920 and V_{bias}(m+2) 925 may switch from BIASM to BIASL. Either BIASH or BIASL may be provided at V_{bias}(m) 920 and V_{bias}(m+2) 925 such that display unit 750 is at a particular polarity (i.e., the electric fields between its electrodes point in particular directions) to reduce charge accumulation affects.

As a result, transitioning V_{bias}(m) 920 and V_{bias}(m+2) 925 to BIASM at time 1150 based on the assertion of CaR(m−4) 915 (i.e., before the assertion of Vᵣₑₛₑₜ(m) 1105) and transitioning V_{bias}(m) 920 and V_{bias}(m+2) 925 based on the assertion of CaG(m+4) 930 (i.e., after the assertion of V_{row}(m+2) 1120) may allow rows m and m+2 to be reset and a voltage provided to the corresponding V_{d} electrodes 860 such that IBD 803 can provide both V_{bias}(m) 920 and V_{bias}(m+2) 925 with the same circuit at the same or similar times, resulting in fewer TFTs. That is, ensuring that V_{bias}(m) 920 and V_{bias}(m+2) 925 transition to a voltage of BIASM before any one of them is reset (through assertions of Vᵣₑₛₑₜ(m) 1105 and Vᵣₑₛₑₜ(m+2) 1110), and transition V_{bias}(m) 920 and V_{bias}(m+2) 925 from BIASM to BIASH or BIASL after rows m and m+2 receive the row signals (through assertions of V_{row}(m) 1115 and V_{row}(m+2) 1120) allows for the IBD to provide V_{bias}(m+2) 925 and V_{bias}(m) 920 together.

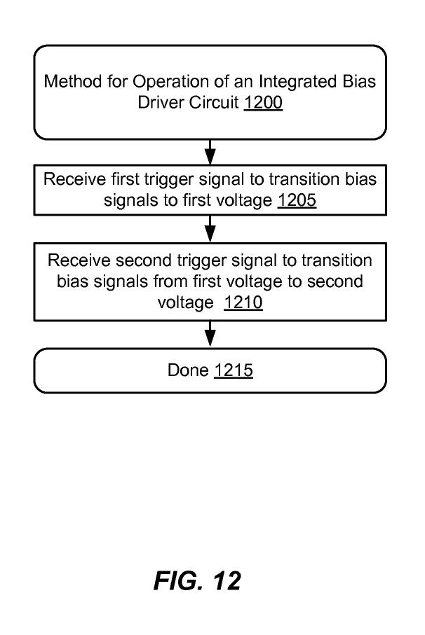

FIG. 12 is a flow diagram illustrating a method for operation of an integrated bias driver circuit. In method 1200, at block 1205, an integrated bias driver circuit can receive a trigger signal to transition bias signals to a first voltage. For example, as previously discussed, IBD 803 in FIG. 9B can receive CaR(m−4) 915 from IRD 802 when it asserts reset signals for prior rows. As a result, IBD 803 may drive both V_{bias}(m) 920 and V_{bias}(m+2) 925 to BIASM. At block 1210, the integrated bias driver circuit can receive a second trigger signal to transition the bias signals from the first voltage to the second voltage. For example, as previously discussed, IBD 803 in FIG. 9B can receive CaG(m+4) 930 from IGD 801 when it asserts V_{row}(m+4) 935 for rows subsequent to row m (i.e., row m+4). The method is done at block 1215.

The number of TFTs used to implement IGDs and IRDs in FIG. 9B can also be reduced. In some implementations, multiple IRDs may provide functionality similar to a shift register, each output of the IRDs being individually asserted one-at-a-time and row-by-row (and de-asserted when another output is to be asserted), similar to a single bit being shifted through a shift register. Likewise, multiple IGDs may also provide similar functionality.

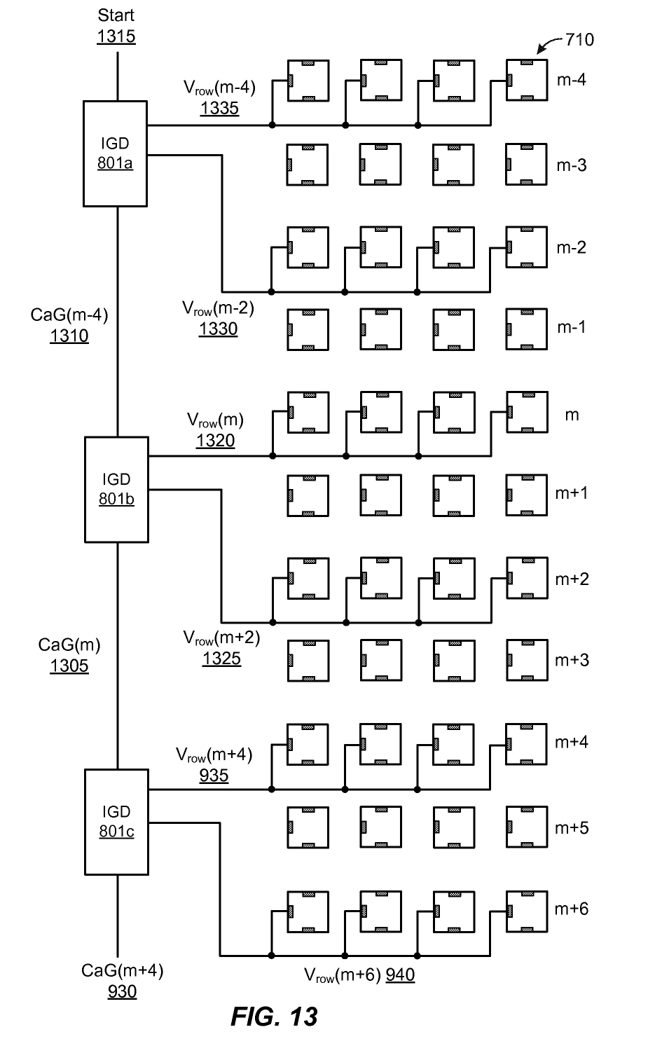

FIG. 13 is an example of a system block diagram illustrating an integrated gate driver circuit providing signals to IMODs. In FIG. 13, IGDs 801a-801c each provides V_{row} 830 in FIG. 8 for two rows of display modules 710 rather than a single row. For example, in FIG. 13, IGD 801a (depicted as IGD 801 in FIG. 9B) may receive start signal 1315 (e.g., from driver controller 29, as discussed later) and assert V_{row}(m−4) 1335 first and V_{row}(m−2) 1330 second. Additionally, when (or after) V_{row}(m−4) 1335 is asserted, IGD 801a may also assert CaG(m−4) 1310 as a carry signal indicating that V_{row}(m−4) 1335 was asserted and provided to IGD 801b, as well as an IBD (e.g., IBD 803 in FIG. 9B). IGD 801b may assert V_{row}(m) 1320 after V_{row}(m−2) 1330 is asserted by IGD 801a. IGD 801b may also assert V_{row}(m+2) 1325 after asserting V_{row}(m) 1320. Additionally, IGD 801b may assert CaG(m) 1305 when (or after) V_{row}(m) 1320 is asserted. IGD 801c (also depicted as IGD 801 in FIG. 9B) may provide similar functionality for rows m+4 and m+6 to provide V_{row}(m+4) 935, V_{row}(m+6) 940, and CaG(m+4) 930. Multiple IRDs may also be used in a similar manner as IGDs 801a-801c in FIG. 13 and provide Vᵣₑₛₑₜ 895 in FIG. 8 for the rows, along with similar carry signals. Other IGDs may provide signals for rows, too.

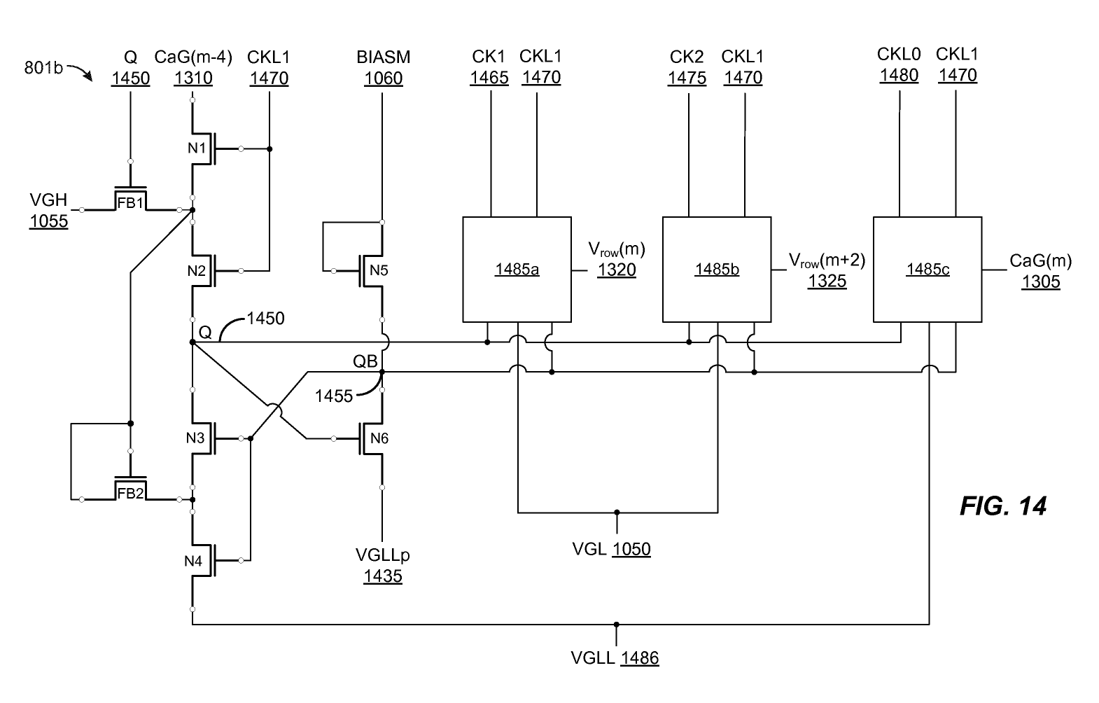

FIG. 14 is a circuit schematic of an example of an integrated gate driver circuit. In particular, FIG. 14 portrays IGD 801b in FIG. 13 providing V_{row}(m) 1320, V_{row}(m+2) 1325, and CaG(m) 1305 from three output buffers 1485a, 1485b, and 1485c, respectively though the circuit may be used to implement IGD 801a, IGD 801c, or an IRD (e.g., IRD 802 in FIG. 9B). Each of the output buffers 1485a-c receives two clock signals as inputs. For example, output buffer 1485a receives CK1 1465 and CKL1 1470, output buffer 1485b receives CK2 1475 and CKL1 1470, and output buffer 1485c receives CKL0 1480 and CKL1 1470. In FIG. 14, voltages on charge node Q 1450 and node QB 1455 are provided by transistors N1-N6 implementing a latch to be shared (i.e., a shared latch stage) and used by output buffers 1485a-c (i.e., output buffer stages) to provide V_{row}(m) 1320, V_{row}(m+2) 1325, and CaG(m+2) 1305 in a sequential order based on the clock signals provided to output buffers 1485a-c and how output buffers 1485a-c are coupled with charge node Q 1450.

The circuit schematic of FIG. 14 also includes feedback transistors FB1 and FB2, which reduce leakage from charge node Q 1450, as described in U.S. patent application Publication Ser. No. 14/642,248, titled DRIVER CIRCUIT WITH REDUCED LEAKAGE, by Kim et al., filed on Mar. 9, 2015, which is hereby incorporated by reference in its entirety and for all purposes.

In FIG. 14, BIASM 1060 may be 0 V, VGLL 1486 and VGLLp 1435 may be −16 V, VGL 1050 may be −12 V, and VGH may be 16 V voltage sources.

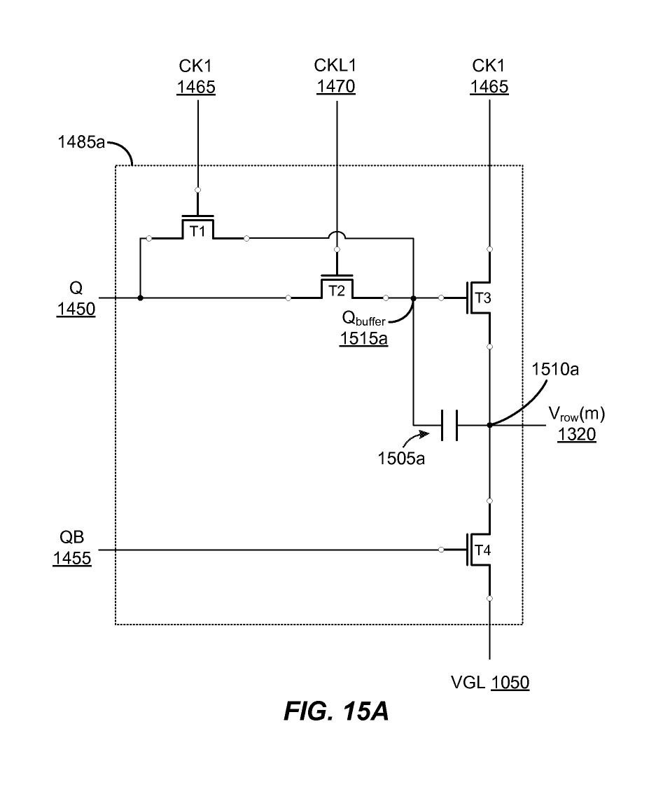

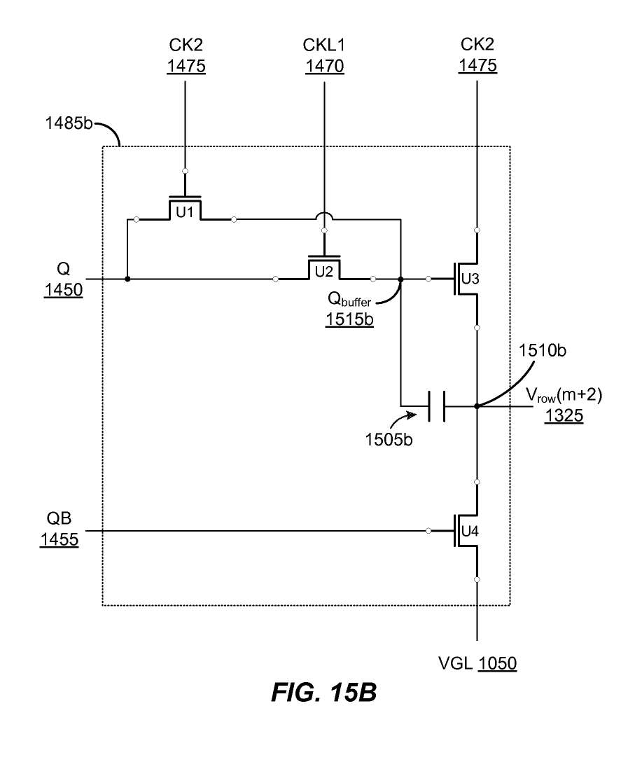

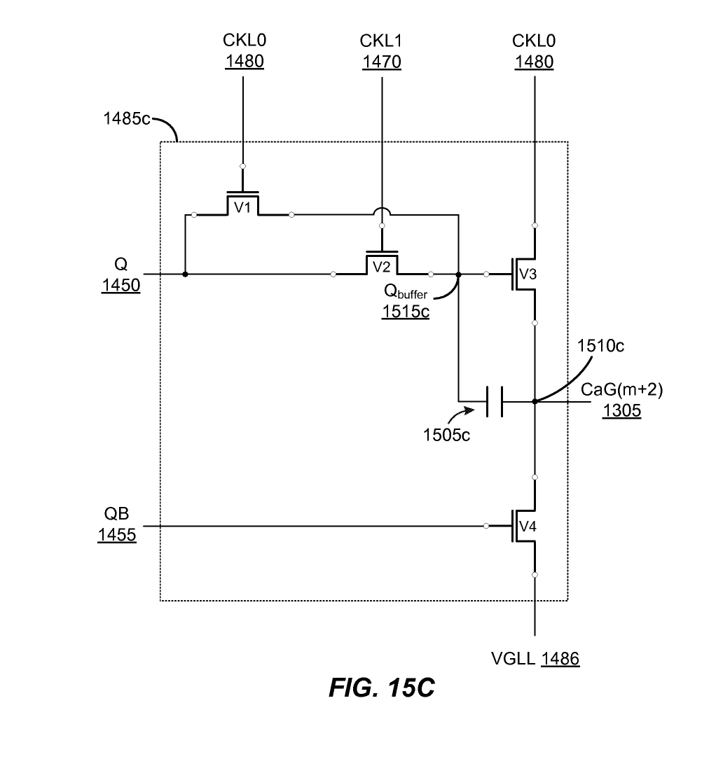

FIGS. 15A-15C are circuit schematics of examples of output buffers of an integrated gate driver circuit. The output buffers in FIGS. 15A-C can also be used to implement output buffers in an IRD. FIG. 15A portrays output buffer 1485a in FIG. 14. In FIG. 15A, CK1 1465 is coupled with a gate (or control) terminal of transistor T1 and CKL1 1470 is coupled with a gate terminal of transistor T2. CK1 1465 is also coupled with a terminal of transistor T3. Charge node Q 1450 (provided by the shared latch of FIG. 14) is coupled with terminals of both transistors T1 and T2. The other terminals of transistors T1 and T2 are both coupled with the gate of transistor T3 to define output buffer charge node Q_{buffer} 1515a. Transistors T3 and T4 of output buffer 1485a are coupled together to provide V_{row}(m) 1320 at output buffer output node 1510a. QB node 1455 provided by the shared latch is coupled with a gate terminal of transistor T4. Additionally, capacitor 1505 is coupled with output buffer charge node Q_{buffer} 1515a and output buffer node 1510a.

FIGS. 15B and 15C portray output buffers 1485b and 1485c, respectively, and include a similar arrangement of components with different clock signals. For example, in FIG. 15B, CK2 1475 is coupled with transistors U1 and U3 of output buffer 1485b. In FIG. 15C, CKL0 1480 is coupled with transistors V1 and V3 of output buffer 1485c. The selection of clocks provided to the respective transistors of each of output buffers 1485a-c allows each to electrically couple the corresponding output buffer charge node Q_{buffer} 1515a-c with charge node Q 1450 of the shared latch when it is driven high in a first phase or operation to drive output buffer charge node Q_{buffer} 1515a-c high as well, but allow for each output of the output buffers 1485a-c to be asserted one-at-a-time to provide a sequence of assertions for V_{row}(m) 1320, V_{row}(m+2) 1325, and CaG(m+2) 1305 when charge node Q 1450 is floating after being driven high in a second phase or operation. Each of the outputs can be asserted individually (while the others are de-asserted) in separate periods that make up the second phase or operation.

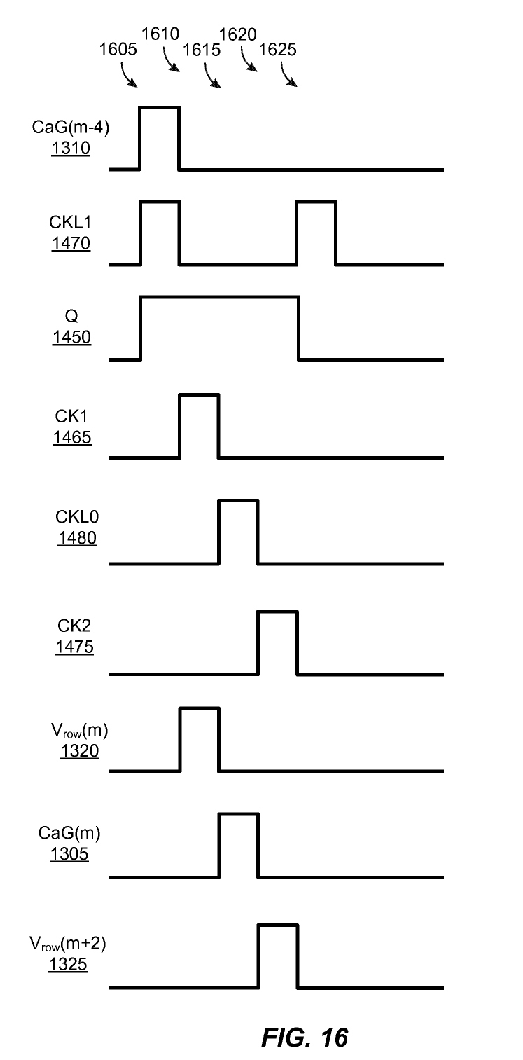

In more detail, FIG. 16 is an example of a timing diagram for operation of an integrated gate driver circuit. In FIG. 16, at time 1605, CaG(m−4) 1310 is high and CKL1 1470 is high, resulting in transistors N1 and N2 in FIG. 14 being turned on because CKL1 1470 is high and coupled to the gates of transistors N1 and N2, and therefore, CaG(m−4) 1310 is applied to charge node Q 1450 (i.e., transistor N7 drives charge node Q 1450 to the voltage of CaG(m−4) 1310) as a first phase. Accordingly, charge node Q 1450 goes high at time 1605. QB node 1455 is low because when charge node Q 1450 is high, transistor N6 turns on and pulls QB node 1455 to VGLLp 1435.

Additionally, since CKL1 1470 is high at time 1605, transistors T2, U2, and V2 in output buffers 1485a-c turn on, charging output buffer charge nodes Q_{buffer} 1515a-c with the voltage of charge node Q 1450, and therefore, output buffer charge nodes Q_{buffer} 1515a-c also go high with charge node Q 1450. As a result, charge node Q 1450 and output buffer charge nodes Q_{buffer} 1515a-c are all charged based on the assertion of the carry signal (CaG(m−4) 1310 in FIG. 16) of a prior driver circuit. Transistor T1 of output buffer 1485a in FIG. 15A, transistor U1 of output buffer 1485b in FIG. 15B, and transistor V1 of output buffer 1485c in FIG. 15C are all turned off (i.e., electrically non-conductive) because CK1 1465, CK2 1475, and CKL0 1480 are all low at time 1605.

Additionally, transistors T3, U3, and V3 in output buffers 1485a-c also turn on because, as previously discussed, output buffer charge nodes Q_{buffer} 1515a-c are all high. As a result, the voltages on CK1 1465, CK2 1475, and CKL0 1480 are provided on output buffer output nodes 1510a-c, which results in V_{row}(m) 1320, V_{row}(m+2) 1325, and CaG(m+2) 1305 all being low because CK1 1465, CK2 1475, and CKL0 1480 are all low at time 1605. Transistors T4, U4, and V4 of output buffers 1485a-c are turned off at time 1605 because node QB 1455 of the shared latch is low, as previously discussed.

Next, at time 1610, CKL1 1470 goes low, resulting in both transistors N1 and N2 of the shared latch in FIG. 14 turning off. As a result, transistor N2 is no longer driving charge node Q 1450 in a second phase characterizing the state of charge node Q 1450. Since QB node 1455 is also low, transistors N3 and N4 are also off and also not driving charge node QB 1450, for example by pulling it down to VGLL 1486. Accordingly, charge node Q 1450 is no longer being driven, and therefore, is floating (i.e., not being pulled high or low). Additionally, since CKL1 1470 is low at time 1610, transistors T2, U2, and V2 of output buffers 1485a-c are also turned off.

At time 1610, CK2 1475 and CKL0 1480 are also low. Accordingly, transistor U1 in output buffer 1485b in FIG. 15B and transistor V1 in output buffer 1485c in FIG. 15C are also turned off. However, also at time 1610, CK1 1465 goes high, resulting in transistor T1 1465 turning on. As a result, output buffer charge node Q_{buffer} 1515a is driven by transistor T1 of output buffer 1485a in FIG. 15A, allowing for transistor T3 to turn on and provide a voltage corresponding to CK1 1465 to output buffer output node 1510a (i.e., V_{row}(m) 1320). Since CK1 1465 is high, the voltage at output buffer output node 1510a would be high, resulting in an assertion of V_{row}(m) 1320. Additionally, output buffer charge node Q_{buffer} 1515a may “bootstrap,” or experience a boosting voltage because it may be susceptible to capacitive coupling through transistor T3 and the clock signal of CK1 1465. The bootstrapping of output buffer charge node Q_{buffer} 1515a allows its voltage to be higher than the voltage of CK1 1465, which in turn quickly turns on transistor T3 to assert V_{row}(m) 1320. That is, transistor T3 may turn on faster with the boosting voltage applied to its gate than if output buffer charge node Q_{buffer} 1515a did not experience bootstrapping. Accordingly, the voltage at output buffer charge node Q_{buffer} 1515a may be stepped up beyond the level set previously at time 1605. However, since output buffer charge node Q_{buffer} 1515a is electrically isolated from output buffer charge nodes Q_{buffer} 1515b and 1515c since transistors U1, U2, V1, and V2 are turned off at time 1610, and therefore, the bootstrapping does not affect the other output buffer charge nodes. Accordingly, output buffer output nodes 1510b and 1510c may be at a low voltage, and therefore, V_{row}(m+2) 1325 and CaG(m) 1305 are low (i.e., de-asserted).

Next, at time 1615, CK1 1465 goes low and CKL0 1480 goes high. As a result, transistor T1 of output buffer 1485a in FIG. 15A turns off, electrically decoupling or disconnecting output buffer charge node Q_{buffer} 1515a such that it is isolated from charge node Q 1450 provided by the shared latch. However, since CKL0 1480 is high, transistor V1 of output buffer 1485c in FIG. 15C turns on, transistor V3 turns on, output buffer charge node Q_{buffer} 1515b may become bootstrapped since CKL0 1480 switches high, and transistor V3 drives output buffer output nodes 1510c to a high voltage, resulting in an assertion of CaG(m) 1305 while V_{row}(m) 1320 goes low because it generally follows CK1 1465 which is low. Additionally, V_{row}(m+2) 1325 remains low. At time 1620, a similar process may repeat again, but for output buffer 1485b. Accordingly, when the second phase occurs (i.e., when charge node Q 1450 is floating), sequential “periods” in which the outputs of output buffers 1485a-c are asserted occur, with one being asserted while the other two are de-asserted.

In some implementations, asserting CaG(m) 1305 at a time between the assertions of V_{row}(m) 1320 and V_{row}(m+2) 1325 can reduce the number of clock signals used to assert the outputs of output buffer 1485a-c.

Next, at time 1625, CKL1 1470 goes high, resulting in transistors N1 and N2 in FIG. 14 turning on and CaG(m−4) 1310, which is low, being applied to charge node Q 1450. Accordingly, charge node Q 1450 is discharged and goes low. This results in transistor N6 turning off (i.e., which was turned on at time 1605 such that QB node 1455 was pulled down to VGLLp 1435, as previously discussed). As a result, transistor N5 in FIG. 14 can bias QB node 1455 to the voltage of BIASM 1060, which causes transistors T4, U4, and V4 of output buffers 1485a-c in FIGS. 15A-C to turn on, and therefore, pull V_{row}(m) 1320 and V_{row}(m+2) 1325 low to VGL 1050 and CaG(m+2) 1305 low to VGLL 1486 to keep the signals de-asserted after being asserted until the next time CaG(m−4) 1310 and CKL1 1470 are both asserted again at the same time.

Output buffers 1485a-c include capacitors 1505a-c that may benefit bootstrapping. However, in some implementations, capacitors 1505a-c may be removed. In some implementations, some output buffers may include a capacitor, but other output buffers may not. For example, output buffer 1485a may include capacitor 1505a, but output buffers 1485b and 1485c may not include capacitors 1505b and 1505c, respectively.

Using the shared latch with multiple output buffers 1485a-c can reduce the number of TFTs, for example, by 20%.

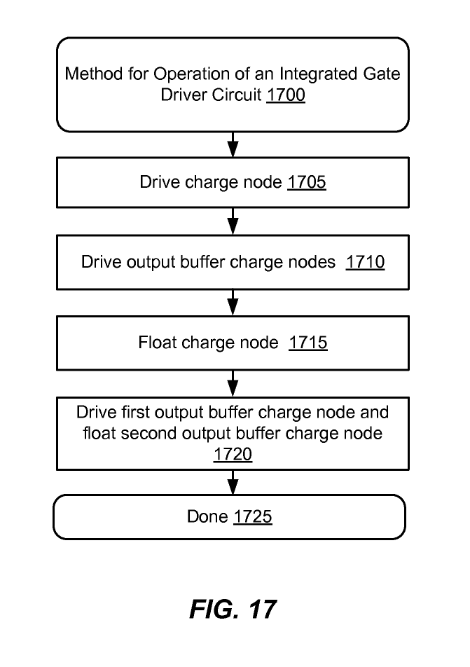

FIG. 17 is a flow diagram illustrating a method for operation of an integrated gate driver circuit. In method 1700, at block 1705, a charge node can be driven. For example, charge node Q 1450 can be charged or driven when CaG(m−4) and CKL 1470 are high. At block 1710, output buffer charge nodes can be driven. For example, transistors T2, U2, and V2 can be turned on when charge node Q 1450 is driven to charge corresponding output buffer charge nodes Q_{buffer} 1515a-c. At block 1715, the charge node can be floated. For example, charge node Q 1450 can be floating when CKL1 1470 is low. At block 1720, a first output buffer charge node can be driven while other output buffer charge nodes can be floating. For example, transistor T1 of output buffer 1485a can be turned on and transistors U1 and V1 of output buffers 1485b and 1485c can be turned off such that the output of output buffer 1485a is asserted while the outputs of output buffers 1485b and 1485c are de-asserted. The method is done at block 1725.

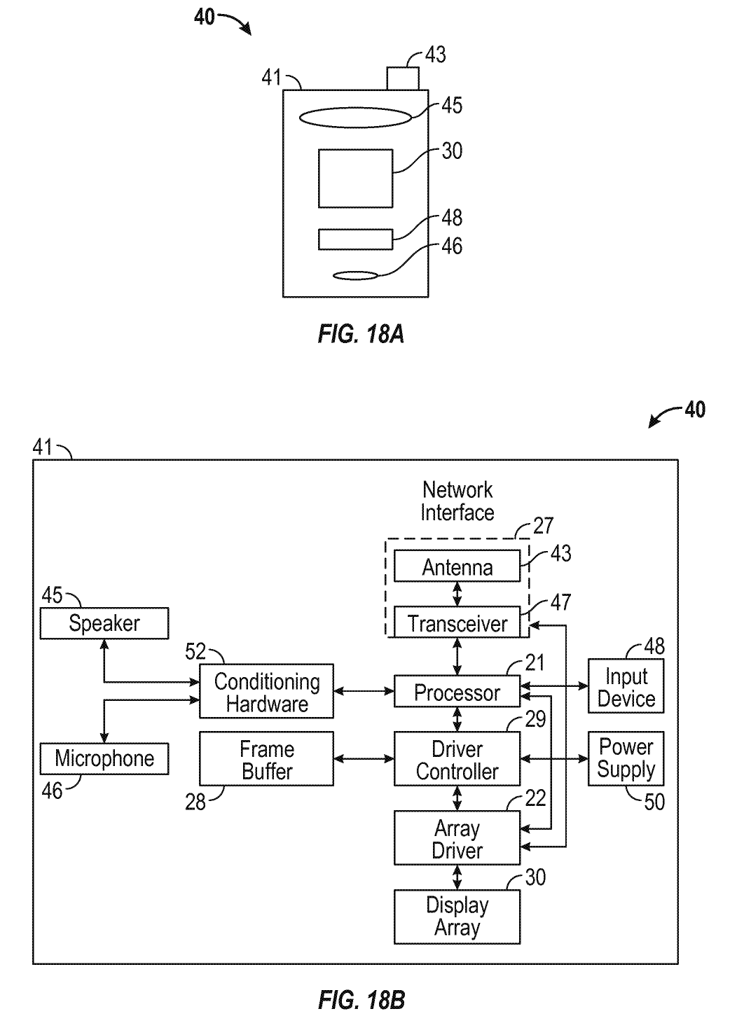

FIGS. 18A and 18B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 18A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 18A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

Some of the examples of circuit schematics described herein use NMOS transistors. However, PMOS transistors can also be used.

Additionally, the circuits described in the examples as driver circuits for displays. However, the circuits can also be used in other scenarios (i.e., other than displays).

What is claimed is:

1. A circuit capable of biasing a first charge node and electrically coupling the biased first charge node with buffer charge nodes of a set of output buffers in a first phase, and capable of sequentially electrically coupling the buffer charge nodes of the output buffers of the set of output buffers in a second phase occurring after the first phase, the first charge node floating during the second phase, and corresponding outputs of the output buffers being sequentially asserted during the second phase.

2. The circuit of claim 1, wherein the set of output buffers includes a first buffer comprising:
a first switch having an associated first terminal and an associated second terminal, the first terminal of the first switch coupled with the first charge node;
a second switch having an associated first terminal and an associated second terminal, the first terminal of the second switch coupled with the first charge node, and the second terminal of the second switch coupled with the second terminal of the first switch to define a first buffer charge node of the buffer charge nodes.

3. The circuit of claim 2, wherein the first switch has a control terminal coupled with a first clock, and the second switch has a control terminal coupled with a second clock, the second switch turned on by the second clock during the first phase, the first switch turned on by the first clock during the second phase.

4. The circuit of claim 3, further comprising:
a third switch having a first terminal, a second terminal, and a control terminal, the control terminal coupled with the first buffer charge node, the first terminal coupled with the first clock, the second terminal to provide a first output of the corresponding outputs of the output buffers.

5. The circuit of claim 4, further comprising:
a fourth switch having a first terminal and a control terminal, the first terminal coupled with the second terminal of the third switch, the control terminal coupled with a second charge node.

6. The circuit of claim 4, further comprising:
a capacitor having a first terminal and a second terminal, the first terminal coupled with the first buffer charge node, and the second terminal coupled with the second terminal of the third switch.

7. The circuit of claim 1, wherein the set of output buffers includes a first output buffer and a second output buffer, the second phase includes a first period and a second period, an output of the first output buffer asserted and an output of the second output de-asserted during the first period, the output of the first output buffer de-asserted and the output of the second output asserted during the second period.

8. The circuit of claim 7, wherein the first output buffer includes a first buffer charge node and the second output buffer includes a second buffer charge node, the first buffer charge node electrically coupled with the first charge node in the first period, the second buffer charge node electrically coupled with the first charge node in the second period.

9. The circuit of claim 1, further comprising:
a display including a plurality of display elements;
a processor that is configured to communicate with the display, the processor being configured to process image data; and
a memory device that is configured to communicate with the processor.

10. The circuit of claim 9, further comprising:
a driver circuit including the circuit and configured to send at least one signal to the display; and
a controller configured to send at least a portion of the image data to the driver circuit.

11. The circuit of claim 9, further comprising:
an image source module configured to send the image data to the processor, wherein the image source module includes a component selected from the group consisting of at least one of a receiver, a transceiver, and a transmitter.

12. The circuit of claim 1, wherein the corresponding outputs of the output buffers being sequentially asserted during the second phase includes assertions of a first row signal, a carry signal, and a second row signal, the carry signal asserted after the first row signal and before the second row signal.

13. A circuit comprising:
a latch circuit capable of driving a charge node in a first operation and floating the charge node in a second operation;
a first output buffer coupled with the charge node, the first output buffer having a first output buffer charge node; and
a second output buffer coupled with the charge node, the first output buffer having a second output buffer charge node, wherein both the first output buffer charge node and the second output buffer charge node are driven using the charge node during the first operation, and one of the first output buffer charge node and the second output buffer charge node is driven using the charge node during the second operation to assert an output signal corresponding to an output of the one of the first output buffer charge node and the second output buffer charge node.

14. The circuit of claim 13, wherein the first output buffer comprises:
a first switch having a first terminal and a second terminal, the first terminal coupled with the charge node;
a second switch having a first terminal and a second terminal, the first terminal coupled with the charge node, and the second terminal coupled with the second terminal of the first switch to define the first output buffer charge node.

15. The circuit of claim 14, wherein the first switch has a control terminal coupled with a first clock, and the second switch has a control terminal coupled with a second clock, the second switch turned on by the second clock during the first operation, the first switch turned on by the first clock during the second operation.

16. The circuit of claim 15, wherein the second output buffer comprises:
a third switch having a first terminal and a second terminal, the first terminal coupled with the charge node;
a fourth switch having a first terminal and a second terminal, the first terminal coupled with the charge node, and the second terminal coupled with the second terminal of the third switch to define the second output buffer charge node.

17. The circuit of claim 16, wherein the third switch has a control terminal coupled with a third clock, and the fourth switch has a control terminal coupled with the second clock, the fourth switch turned on by the second clock during the first phase, the third switch turned on by the third clock during the second phase after the first switch is turned on.

18. The circuit of claim 17, further comprising:
a third output buffer coupled with the charge node.

19. A method comprising:
driving a charge node of a circuit;
turning on a first switch of a first output buffer and a second switch of a second output buffer to drive a first output buffer charge node of the first output buffer and a second output buffer charge node of the second output buffer;
floating the charge node;
turning off the first switch and the second switch; and
turning on a third switch of the first output buffer to drive the first output buffer charge node based on the floating charge node, wherein the second output buffer charge node is floating.

20. The method of claim 19, further comprising:
asserting an output of the first output buffer responsive to the third switch turning on.
